(19) United States
(12) Patent Application Publication
(10) Pub. No.: US 2010/0132261 A1
(43) Pub. Date: Jun. 3, 2010

(54) GUIDE RAIL ASSEMBLY AND DRIVING ELEMENT FOR MOTOR VEHICLE WINDOW LIFTERS AND METHOD FOR THE PRODUCTION THEREOF

(76) Inventors: Harald Krüger, Erlangen (DE); Udo Taubmann, Bad Rodach (DE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/530,790

(22) PCT Filed: Mar. 31, 2008
(86) PCT No.: PCT/EP2008/002610

§ 371 Date: Jan. 11, 2010

(30) Foreign Application Priority Data
Apr. 5, 2007 (DE) 102007016953.3

(51) Int. Cl. E05F 15/08; E05F 11/38; B23P 11/00; B29C 45/44

(52) U.S. Cl. 49/360; 49/404; 29/428; 264/318

(57) ABSTRACT

A guide rail assembly for motor vehicle window lifters and a method for the production thereof. Two guide webs having protrusions formed thereon form a guide rail on a carrier plate made from a plastic material. The guide webs may be bent elastically inwards or outwards, enabling the driving element to be clipped on by pushing it on in the vehicle's transverse direction y and considerably simplifies production in an injection moulding process because the guide rail may be removed by elastically bending the guide rails such that a smaller number of sliders is required in the moulding tool. In one embodiment, there is also provided a driving element comprising a body of a first material and, securely held therein, sliding inserts comprised of a second material which material ensures a particularly good tribological pairing with the material of the associated guide web.

The present application claims the priority of German patent application no. 10 2007 016 953.3 “Guide Rail Assembly and Driving Element for Motor Vehicle Window Lifters and Method for the Production Thereof” filed on 5 Apr. 2007, the content of which is expressly included herewith by way of reference for the purposes of disclosure.

### FIELD OF THE INVENTION

The present invention relates in general to guide rail assemblies made of plastic material for motor vehicle window lifters and relates in particular to a guide rail assembly according to the preamble of claim 1, a driving element (follower) for motor vehicle window lifters and a method for the production thereof.

### BACKGROUND OF THE INVENTION

From the prior art are known plastic carrier plates, also referred to as assembly carriers, which after being connected to a module carrier enable a moisture-proof separation of the wet space and the dry space, a pre-assembly of door module components and door module functions, for example of door operating elements, electric window lifters, side airbag module, speakers or similar, and allow for high mechanical strength requirements with easy installation. The advantage of using plastic as a material emerges particularly in that it is possible as a result to produce the carrier plate in a simple manner by means of injection moulding.

Examples of such carrier plates are disclosed for example in DE 199 44 965 A1 by the applicant or DE 197 32 225 A1 (corresponding to U.S. Pat. No. 5,906,072), the content of which is expressly included in the present application by way of reference.

DE 10 2005 033 115 A1 (corresponding to WO 2007/006296 A1) discloses a unit carrier made of plastic material for a motor vehicle door with a guide rail moulded integrally thereon in one piece. The guide rail should be characterised by high stability and rigidity in order to resist the considerable forces arising during operation of the guide rail. The guide rail comprises two guide webs spaced apart from each other formed on each of which are guide protrusions that protrude inwards away from the respective guide web. Additional stiffening beads and concavities are provided in the region of the guide rail to increase the rigidity. Thus the guide webs are not bendable in the sense of the present application.

FIG. 7 of this application illustrates an injection moulding tool for the production of such a guide rail. The injection moulding tool comprises one central slider and two lateral sliders in the region of the guide rail, which have lateral protrusions to form the guide protrusions on the guide webs. Thus the total number of the injection moulding tool's sliders is comparatively high which increases the costs for the injection mould and also for the injection moulding process. As there are no recesses provided on the central slider for moulding of the guide protrusions, the principle of demoulding the guide rail assembly from (out of) the injection moulding tool also deviates distinctly from that according to the present invention.

DE 10 2004 063 514 A1 (corresponding to WO 2006/069 559 A1) relates to a window pane made of synthetic material for motor vehicles. Disclosed is a carrier plate made from a plastic material on which a guide rail is formed integrally. To safeguard against transverse forces, the guide rail is stepped in design as illustrated in FIGS. 2A to 2C. The guide rail does not have two guide webs spaced apart from each other with guide protrusions formed thereon protruding inwards or outwards. The principle of production, particularly demoulding from (out of) an injection moulding tool, also deviates distinctly from the procedure according to the present invention.

DE 36 00 413 C2 (corresponding to U.S. Pat. No. 4,700,508) discloses a central guide rail, formed from a sheet metal profile and fixed to the motor vehicle bodywork, for a motor vehicle window lifter, wherein slide elements are disposed on the guide rail spaced apart from each other and are slidable on flanges of the guide rail which are orientated perpendicularly and parallel to the window pane.

A cost benefit emerges particularly if the guide rail, which serves to guide a driving element serving to connect the window pane to the window lifter, is also made of plastic material, is in particular integrally with the carrier plate, namely by means of injection moulding of a plastic material. In order to guide the window pane and the driving element securely in a direction at right angles to the vehicle's longitudinal direction, the driving element must engage behind the guide rail's guiding profile. Only in this way does the driving element remain securely guided on the guide rail even at comparatively high accelerations in the motor vehicle's transverse direction such as occur particularly when the door is slammed shut. As explained previously particularly on the basis of DE 10 2005 033 115 A1, comparatively large sliders are necessary in the moulding tool in order to implement such a rear grip when injection moulding the carrier plate from a plastic material. This increases the cycle time when injection moulding the carrier plate and thus also the costs and risks.

### SUMMARY OF THE INVENTION

Thus it is an object of the present invention to provide a guide rail assembly made of a plastic material for motor vehicle window lifters, said assembly being inexpensive and easy to produce and install and which reliably guides a driving element. According to a further aspect of the present invention, there is also to be provides a driving element for a motor vehicle window lifter made of a plastic material, said driving element being inexpensive and easy to produce and install and being reliably guided on a guide rail, in particular on a guide rail which will be explained subsequently in greater detail. According to further aspects of the present invention, there is also to be provided a method for the production of a guide rail assembly and a driving element, as explained subsequently.

These and further objects are achieved according to the present invention by means of a guide rail assembly having the features according to claim 1, by a driving element or follower according to claim 20 and by a method for the production or assembly thereof according to claims 17, 27 and 28, respectively. Further advantageous embodiments are the subject-matter of the related dependent claims.

Thus the present invention proceeds according to a first aspect from a guide rail assembly for motor vehicle window lifters, which is formed from a plastic material and comprises a flat carrier and at least one guide rail for guiding a window lifter driving element, wherein the guide rail has two guide webs spaced apart from each other, which protrude from the carrier, and wherein guide protrusions are formed on the guide webs, each of which extends over the entire guidance length of the guide webs, and which protrude by a predetermined distance inwards or outwards from the respective guide web such that the driving element cooperating therewith is securely guided against detachment perpendicular to the carrier.

According to the invention, the guide webs are designed such that in the region of the guide protrusions they are each elastically bendable inwards or outwards by at least the predetermined distance. Thus according to the invention, the guide rail may be demoulded from an injection moulding tool by means of elastic deformation of its guide webs. Consequently, according to the invention, it is possible to reduce the number of sliders necessary for the moulding tool. In particular, no cross sliders or transversal sliders are necessary for forming the guide webs as all the moulding tool parts can be withdrawn in the same direction in order to demould the guide rail from (out of) the moulding tool.

In this case the guide protrusions protrude preferably perpendicularly or, according to further embodiments, virtually perpendicularly away from the carrier and are formed integrally therewith. The carrier may, according to a further embodiment, be extended into a carrier plate basically known from the prior art, also referred to as a door module carrier, which can also carry at least one further guide rail. At the same time, the guide rail is formed according to the invention from two guide webs spaced apart from each other, which together form a guide rail having a substantially U-shaped cross-section, wherein a guide protrusion protrudes inwards and/or outwards from the inside or outside of the guide webs, said guide protrusion cooperating positively with correspondingly formed sections of the driving element in order to guide it securely in the guide rail's longitudinal direction and to safeguard against detachment of the driving element perpendicular to the longitudinal direction, i.e. in the intended transverse direction of the vehicle. For this purpose the driving element preferably engages behind one or a plurality of the guide rail's guiding protrusions as explained below.

To implement such a rear grip, the protrusions each have, according to a further embodiment, a guide surface facing towards the carrier, which preferably represents a plane, wherein the notional extension of the guide surface includes a first acute angle with a line perpendicular to the carrier. The protrusion of the inclined guide surface onto the plane defined by the carrier in the region of the guide rail thereby defines the predetermined distance referred to previously by which the guide webs are bent elastically inwards or outwards on demoulding from the moulding tool. Sections of a moulding tool also engage, in a similar manner to the driving element, behind the guide protrusions after injection moulding of the guide rail assembly. According to the invention, demoulding of the guide rail assembly from the moulding tool is made easier in that the guide surface previously mentioned extends at an angle and not in parallel with the carrier. According to a further embodiment, however, such a rear grip can also be still be implemented in principle if the guide surface previously mentioned extends in parallel with or substantially in parallel with the carrier.

According to a further embodiment, the protrusions each also have a bevel facing away from the carrier, the notional extension o which includes a second acute angle with a line perpendicular to the carrier. In this case the first acute angle is smaller than the second acute angle. The bevel facing away from the carrier is thus formed preferably steeply in the installation (assembly) direction to enable effortless clipping or pushing of the driving element onto the guide rail. As a result, it is possible to advantageously reduce installation forces in particular. On the other hand, the guide surface facing the carrier is formed flatter in this case to enable high detachment forces of the driving element perpendicular to the carrier and thus to ensure a high holding force of the driving element on the guide webs. However, the angle must be chosen such that demoulding of the guide rail assembly from the injection mould or from the tool can be carried out without problems, particularly without damage to the guiding regions of the guide rail assembly.

The angles of inclination of the guide surface or bevel referred to previously are appropriately chosen in this case such that the limits of elastic deformability of the material regions concerned are taken into account when designing the tool and when specifying the dimensions of the portions of the guide rail. The demoulding forces arising in this case are not essential for the invention.

According to a further embodiment, the guide protrusions each have a spherical, i.e. essentially ball-shaped or outwardly convex guide surface on the side facing towards the carrier, which merges into the associated guide web at an obtuse angle. It is also possible to implement forcible demoulding of the guide rail assembly from the moulding tool with elastic deformation of the guide webs due to a spherical guide surface.

According to a further embodiment, the guide webs in the region of the guide protrusions are each bendable elastically inwards or outwards by the predetermined distance on operation of a minimum force, whereby the minimum force corresponds to a force required for demoulding of the guide rail or guide rail assembly made of plastic from the moulding tool. Expediently, the required minimum force is greater in this case than a maximum force which corresponds to a maximum holding force of the driving element on the guide rail during intended use. Such a maximum holding force may be specified here, for example, by the driving element's mass multiplied by a maximum intended transverse acceleration, i.e. acceleration in the vehicle's transverse direction. Consequently, sufficient resistance to detachment of the driving element on the guide rail is implemented even without additional securing elements which secure the driving element on the guide rail.

According to a further embodiment, the guide rail assembly referred to above comprises a window lifter driving element having contact sections, which are formed in correspondence with the guide protrusions of the guide webs and cooperate therewith in order to guide the driving element securely perpendicular to the carrier to prevent detachment. Preferably, the window lifter driving element is guided in the process substantially without play in the vehicle's longitudinal direction and secured against tilting about the guide rail's longitudinal axis.

According to a further embodiment, formed in each case on the driving element are securing means which counteract or prevent or inhibit bending of the guide webs. Here the securing means may be permanently in contact on the inner or outer sides of the guide webs or may only come into contact with them when the guide webs are bent inwards or outwards and namely by a distance that is smaller than the predetermined distance previously referred to which would lead to cancellation of the positive fit previously referred to between the driving element and the guide protrusions. At the same time the securing means have sufficient rigidity, particularly in the vehicle's longitudinal direction, to suppress or inhibit bending or further bending of the guide webs.

Expediently, the driving element has a central protrusion which protrudes into an inner side of the essentially U-shaped guiding profile of the guide rail.

The central protrusion may at the same time be thickened in a mushroom-shape in order to implement the rear grip referred to previously, in particular in order to implement a positive fit between the mushroom-shaped thickened section of the driving element and the guide protrusions of the guide webs protruding into the inner volume of the guide rails. In such an embodiment, the securing means are disposed on an outer side of the guide webs, i.e. on a side of the guide webs opposing the guide protrusions.

According to a further embodiment, the securing means are designed as resilient webs, which are bent up at an acute angle and, directed towards a base of the driving element, are inclined towards the outsides of the guide webs. In this way it is possible to implement an advantageously high intrinsic stiffness of the securing webs against outward bending of the guide rail's guide webs. Preferably, in this case the mushroom-shaped thickening on the driving element's central section protrudes further into the inside of the guide rail than the elastic securing webs stand out from the driving element's base. In this way it is possible to virtually exclude detachment of the driving element from the guide rail in the vehicle's transverse direction.

According to a further embodiment, the guide protrusions are provided on the outside of the guide web, whereby resilient securing webs protrude in the manner of wings from the outer sides of the driving element, the front free ends of said securing webs being designed to correspond with the guide protrusions and being in contact therewith. At the same time the driving element is disposed practically jammed against the guide webs of the guide rail which reliably prevents detachment of the driving element from the guide rail in the vehicle's transverse direction. Expediently, the contact surfaces are formed as concave dished webs.

For reliable introduction of the driving element into the guide rail profile referred to previously, introductory bevels are provided at the same time on the sides of the guide protrusions facing away from the carrier, said bevels coming into contact with a central protrusion of the driving element and/or with the securing means on introduction of the driving element into the guide rail and so bringing about elastic bending of the guide webs of the guide rail or of the securing means on introduction of the driving element into the guide rail profile.

According to a further aspect of the present invention, a method is provided for the production of a guide rail assembly, as described previously, by means of injection moulding from a plastic material. To form the guide rail, the moulding tool in this case comprises three movable moulding tool parts, which together form cavities for forming the flat carrier and for forming the guide webs with the guide protrusions formed integrally therewith. According to the invention, in the process the part of the moulding tool defining the guide rail's interior is designed in a wedge shape, thus its marginal surfaces run towards or away from each other at an acute angle. In this case, for forming the guide rail profile, the wedge-shaped moulding tool part is disposed between two adjacent moulding tool parts, which are expediently formed in one piece. According to the invention, these three movable moulding tool parts are withdrawn in the same direction when demoulding the guide rail assembly from the moulding tool. The moulding tool according to the invention thus manages without a cross slider (transverse slider) which conventionally leads to an increased cycle time and thus to higher costs and risks. When the wedge-shaped part of the moulding tool is withdrawn, there is elastic bending of the guide webs forming the guide rail at the same time, as described previously.

According to a further aspect of the present invention, which may also in principle be claimed separately by means of an independent claim, but which is particularly designed or suitable for a guide rail assembly, as described previously, according to the invention a driving element for motor vehicle window lifters is further provided, which has at least one U-shaped longitudinal recess and is comprised of a first material, expediently of plastic and produced in a plastic injection moulding process. According to the invention, the driving element has at least one sliding insert, which is formed from a second material that is different from the first material and which is held securely in the relevant longitudinal recess of the body. At the same time the sliding insert has a guide groove, which is formed to correspond at least in sections to a guide web of the associated guide rail such that the driving element (follower) is movably guided in the guide web's longitudinal direction by positive-fit engagement of the guide web in the guide groove and is secured against detachment perpendicular to the longitudinal direction.

The sliding insert is thus formed as a separate component from a different material such that, according to the invention, it is possible to provide a particularly appropriate tribological pairing for the counterpart, i.e. for the associated guide web.

According to a further preferred embodiment, according to the invention, a guide rail assembly is provided, which comprises a driving element (follower), wherein a longitudinal recess is formed in the driving element, which extends parallel to the carrier's guide webs, and whereby a locking web furthermore protrudes from the carrier, said locking web engaging in the longitudinal recess so as to counteract bending of the web's surfaces forming the longitudinal recess and/or to prevent the at least one sliding insert from popping out of the associated U-shaped longitudinal recess on detachment of the driving element perpendicular to a plane defined by the carrier. In this manner the locking web locks each sliding insert inserted into the driving element.

At the same time, according to the invention, it is possible to simplify the assembly of a guide rail assembly which comprises a guide rail and a driving element engaging therein. The driving elements are conventionally threaded (inserted) into the guide rail profile at the top and bottom end of the guide rail and then slid into a position determining the window lifter's assembly position. As also with the previously mentioned first aspect of the present invention, relating to the guide rail assembly in which the driving element may be pressed onto or clipped into the guide rail under elastic deformation of the guide webs in the vehicle's transverse direction, the driving element may also, according to the second aspect of the present invention, be assembled by pressing on or clipping in under the application of force in the vehicle's transverse direction. In this case, first of all the appropriate sliding insert is placed onto or slid onto the associated guide web, if necessary under elastic deformation of side walls of the U-shaped sliding insert. The driving element is subsequently pushed onto the sliding insert or sliding inserts such that each sliding insert is accommodated in the driving element's associated longitudinal recess and thus a driving element is formed which is securely guided on the guide web in its longitudinal direction but is secured on the guide web against detachment perpendicular to the longitudinal direction, i.e. in the vehicle's transverse direction.

According to a preferred alternative embodiment, the sliding inserts are, however, first inserted in the driving element, in particular clipped in, in order to thus form a pre-assembled driving element unit. This is then placed on the associated guide webs in such a manner that the driving element is movably guided on each guide web in the longitudinal direction thereof and is secured in a direction perpendicular thereto. Subsequently, the driving element is pushed into a region in which the carrier's locking webs engage in the driving element's longitudinal recess in such a manner that bending of the driving element's surfaces forming the longitudinal recess and/or popping of the at least one sliding insert out of the associated U-shaped longitudinal recess on detachment of the driving element perpendicular to a plane defined by the carrier is counteracted such that the sliding inserts are locked or secured in the driving element.

At the same time, the driving element may comprise securing means in order to hold the sliding insert securely in each longitudinal recess. Basically, such securing means may be implemented by means of a friction fit, force fit or positive fit. Especially preferred, the securing means according to the invention are implemented by means of a positive fit. This may be implemented by the engagement of securing protrusions and securing recesses formed on the driving element and the sliding insert respectively into securing recesses and securing protrusions corresponding to the sliding insert or the driving element.

According to a preferred embodiment, the securing means in this case are implemented as protruding longitudinal edges of the driving element's relevant longitudinal recess. Thus the sliding insert may be introduced therein by clipping on of the driving element.

In a further embodiment, having two sliding inserts spaced apart from each other, a central web may be formed between the sliding inserts, said web having a central longitudinal recess, which enables elastic bending of the side walls limiting the driving element's longitudinal recesses when the sliding inserts are clipped in. At the same time, securing hooks, which hold the sliding inserts securely in the longitudinal recess by means of positive fit, may be formed on the central web.

### OVERVIEW OF FIGURES

The invention will be described in the following in an exemplary manner and with reference to the associated drawings, from which will ensue further features, advantages and objects to be achieved. The figures show:

FIG. 1 in a schematic cross-sectional view the engagement of a driving element in a guide rail according to a first embodiment of the present invention;

FIG. 2 in a schematic sectional view three moulding tool parts for injection moulding of the guide rail assembly according to FIG. 1;

FIG. 3 the guide rail assembly according to FIG. 1 in a first phase of demoulding from the moulding tool according to FIG. 2;

FIG. 4 the guide rail assembly according to FIG. 1 in a second phase of demoulding from the moulding tool according to FIG. 2;

FIG. 5 in a schematic cross-sectional view the engagement of a driving element in a guide rail of a guide rail assembly according to a second embodiment of the present invention;

FIG. 6 in a schematic sectional view the production of a guide rail according to a third embodiment of the present invention in a moulding tool with three movable moulding tool parts;

FIG. 7 the cooperation of a driving element with the guide rail according to FIG. 6 according to a third embodiment of the present invention;

FIG. 8 a driving element with two sliding inserts of a different material according to a further embodiment of the present invention;

FIG. 9a a driving element according to a further embodiment of a guide rail assembly of the present invention, which is held securely on the carrier against detachment perpendicular to the carrier using a locking web provided on the carrier;

FIG. 9b in a schematic partial view from above the guide web of the guide rail assembly according to FIG. 9a;

FIG. 10a in a partial section and in a view from above the cooperation of the driving element and the locking web of the guide rail assembly according to FIG. 9a on attaching the driving element to the guide webs close to their end region; and

FIG. 10b in a partial section and in a view from above the cooperation of the driving element and the locking web of the guide rail assembly according to FIG. 9a in a defined working range of the driving element.

Identical reference numerals in the Figures indicate identical elements or element groups or those with substantially the same effect.

### DETAILED DESCRIPTION OF PREFERRED EMBODIMENTS

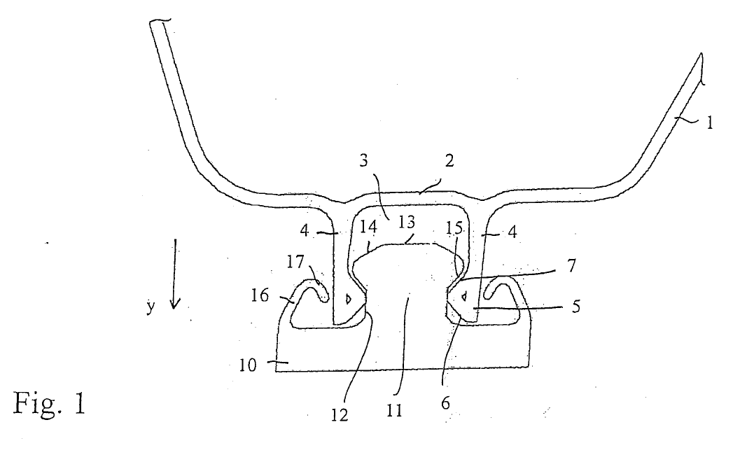

According to FIG. 1, two guide webs 4, which together form a substantially U-shaped rail profile, protrude essentially perpendicularly from carrier plate 1 on which the guide rail is formed, said carrier plate being substantially flat and only a protruding section of which is illustrated for reasons of simplification. According to FIG. 1, protruding into inner space 3 of the rail profile from the insides of guide webs 4 are triangular guide protrusions 5. Guide protrusions 5 each have a bevel 7 facing towards base 2 of the rail profile and an introductory bevel 6 facing away from base 2. Engaging in the rail profile thus formed is a central thickened section 11 of driving element 10. More precisely, the acute angle at which a notional extension line of bevel 7 intersects the plane defined by carrier plate 1 in the region of the guide rail corresponds to the angle at which rear bevels 15 intersect side walls 12 of central section 11. According to FIG. 1, the front ends of guide webs 4 are in contact with the base of driving element 10 in such a manner that driving element 10, due to the positive fit, is guided movably overall on the guide rail thus formed in its longitudinal direction and is secured against detachment from the rail profile in a direction perpendicular thereto, i.e. in the vehicle's transverse direction y.

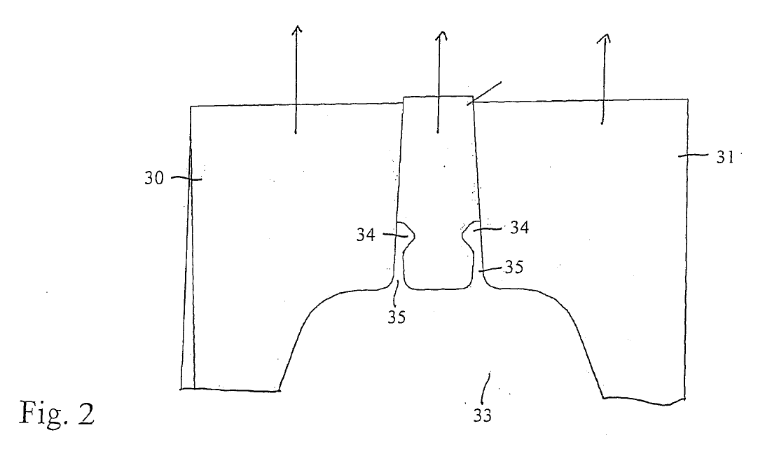

As will be described subsequently with reference to FIGS. 2-4, guide webs 4 may be bent elastically outwards, namely in the region of guide protrusions 5, by at least a distance which corresponds to the distance by which guide protrusions 5 protrude from the inside of guide webs 4, i.e. substantially by at least the height of the point of triangle-shaped guide protrusion 5 relative to the inside of guide web 4. Consequently, driving element 10 may be pressed into or clipped onto the rail profile formed by guide webs 4. For this purpose, formed on the upper front face of central thickened section 11 are two bevels 14, which on being pressed onto driving element 10 ultimately come into contact with introductory bevels 6 and subsequently, on further pressing of driving element 10 onto the rail profile, bring about an expansion of guide webs 4 until finally central thickened section 11 slides at its widest point past pointed, triangle-shaped guide protrusions 5 and slides into inner space 3 of the rail profile. On further pushing on of driving element 10, guide webs 4 ultimately return to the initial position shown in FIG. 1 in which they are pre-tensioned.

According to FIG. 1, driving element 10 also has two wing-like marginal webs 16, 17, which in cross-section almost form a closed equilateral triangle with the base of driving element 10, wherein front free ends 17 are inclined at an acute angle to the base of driving element 10 and are disposed a short distance from the outside of guide webs 4 or, according to a further embodiment (not illustrated) are permanently in contact on the outside of guide webs 4. Webs 16, 17 serve as securing elements in order to additionally secure the driving element against detachment from the guide rail in the vehicle's transverse direction y. According to FIG. 1, inclined marginal web 17 is spaced further from base 2 of the guide rail than the widest part of central thickened section 11. On detaching driving element 10 from the guide rail, guide webs 4 are pressed outwards due to the cooperation of rear bevels 15 with bevels 7. This evasive movement of guide webs 4 is, however, at least obstructed or even prevented by securing webs 16, 17 which depends on the elastic properties of securing webs 16, 17 and their geometric design. It should be emphasized that additional securing webs 16, 17 are not absolutely necessary.

In the embodiment according to FIG. 1, rear bevels 15 of driving element 10 engage behind guide protrusions 5 of guide webs 4. In the embodiment illustrated, the angle at which bevels 7 are inclined towards base 2 is approximately 45 degrees. This acute angle may be varied within broad limits and may even be relatively small but should not be negligibly small so as to enable demoulding of the rail profile from the moulding tool.

A method for injection moulding of the carrier plate with the guide rail according to FIG. 1 is described below with reference to FIGS. 2 to 4. FIG. 2 illustrates three adjacent moulding tool parts 30-32, which together define the carrier plate in the region of the guide rail. In this case moulding tool part 32 is wedge-shaped, i.e. the marginal areas of moulding tool part 32 taper towards one another at a comparatively small acute angle. According to FIG. 2, formed in the marginal areas of wedge-shaped moulding tool part 32 are recesses 34, 35, which define the guide protrusions and guide webs of the subsequent rail profile. Together moulding tool parts 30-32 form a central cavity 33, which is limited by a male mould not illustrated, in order to thus define the shape of the carrier plate. Moulding tool parts 30-32 are slidable in the direction of the arrow for demoulding of the work piece, whereby regions 30, 31 are expediently integrally formed such that sliders 32 forms the second tool part. The third tool part is formed at the same time by the male mould not illustrated, which together with the other tool parts forms the cavity to be filled.

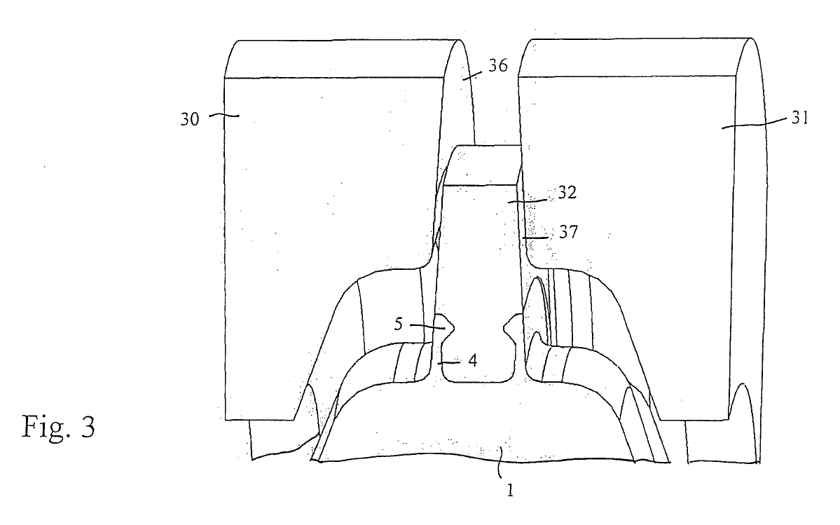

The following procedure is followed to produce the carrier plate with the guide rail: first of all the moulding tool is formed according to FIG. 2 and the male mould not illustrated is inserted. Injection moulding of the carrier plate with the guide rail formed integrally therein is carried out subsequently. Then both lateral moulding tool parts 30 and 31 are first withdrawn in the direction of the arrow for demoulding. This procedure is illustrated schematically in FIG. 3, which is a hugely inflated representation from a perspective point of view. In this state, wedge-shaped moulding tool part 32 continues to be engaged with the guide rail.

In a subsequent step, as shown in FIG. 4, wedge-shaped moulding tool part 32 is then also lifted off in the same direction. In FIG. 4 one can identify triangle-shaped notches 38 formed in marginal areas 37, said notches defining guide protrusions 5 on the insides of guide webs 4. On withdrawal of wedge-shaped moulding tool part 32, guide webs 4 are bent elastically outwards such that the tips of guide protrusions 5 slide on marginal areas 37 until guide webs 4 finally return into the initial position illustrated in FIG. 4 due to their elastic properties.

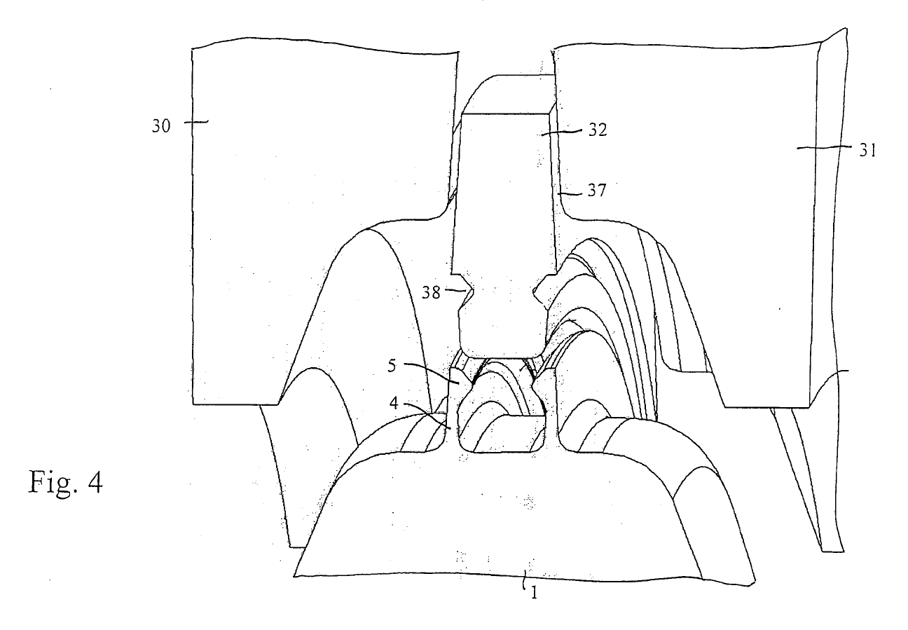

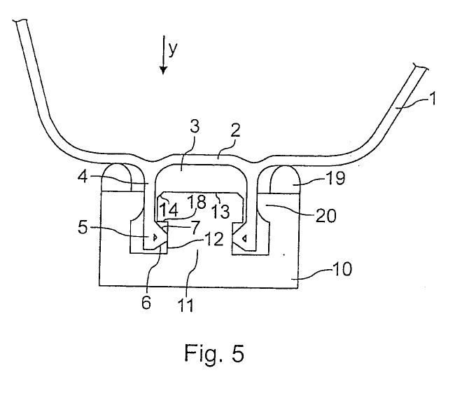

FIG. 5 shows a second embodiment in which driving element 10 can no longer be detached from the guide rail without destroying it. To this end, driving element 10 is formed substantially in a C-shape having two marginal webs 19, which extend perpendicularly to the base of driving element 10. According to FIG. 5, protruding from the insides of marginal webs 19 are two protrusions acting as securing elements, which may be permanently in contact on the outsides of guide webs 4 but which may also be disposed at a short distance from them, said distance being smaller than the predefined distance referred to previously. According to FIG. 5, guide protrusions 5 have on their inside a bevel 7, which cooperates with centrally thickened section 11 of driving element 10. According to FIG. 5, securing protrusions 20 and the widest sections of centrally thickened section 11 are disposed at the same distance from base 2 of the rail profile. In order to detach driving element 10 from the rail profile in the vehicle's transverse direction y, it is necessary not only to bend guide webs 4 outwards but also marginal webs 19 at the same time. Thus it is possible to achieve a high resistance to detachment of driving element 10. Expediently, such a driving element is assembled by threading onto one of the ends of a guide rail.

As can be seen from FIG. 5, rear sides 18 of centrally thickened section 11 extend at a right angle to lateral surfaces 12. Basically, however, an inclined surface may also be provided at this point as in the embodiment according to FIG. 1.

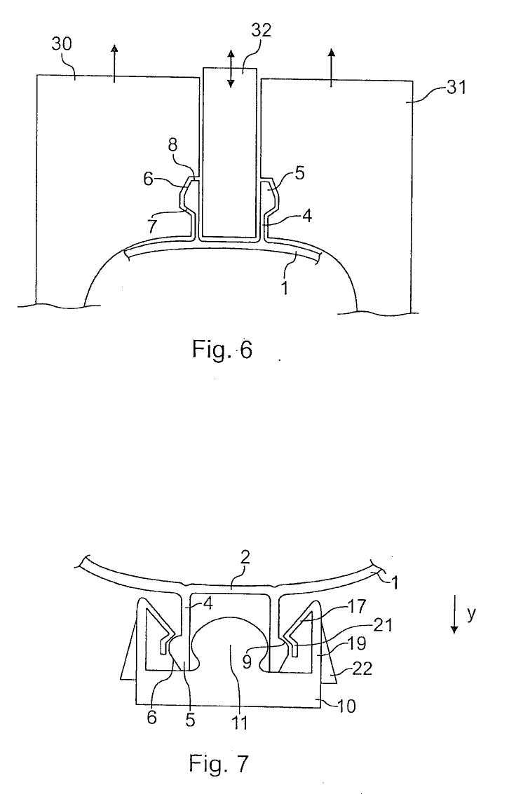

A third embodiment is described below with reference to FIGS. 6 and 7. According to FIG. 7, triangle-shaped guide protrusions 5 protrude from the outsides of guide webs 4. Three moulding tool parts 30-32, as illustrated by way of example in FIG. 6, are used to produce such a rail profile. According to FIG. 6, the spaces, which are defined by guide webs 4 and guide protrusions 5, are formed in the marginal areas of moulding tool part 30, 31. Central moulding tool part 32 is wedge-shaped, i.e. its lateral surfaces taper towards each other at a relatively small acute angle, as described previously on the basis of FIG. 2.

The following procedure is followed to demould such a guide rail: first of all wedge-shaped moulding tool part 32 is withdrawn in the wedge direction illustrated such that the insides of guide webs 4 are exposed. Subsequently, adjacent moulding tool parts 30, 31 are withdrawn in the same direction as indicated by the arrows. In the process, introductory bevels 7 of guide protrusions 5 slide off on the narrowed sections of moulding tool parts 30, 31 which leads to elastic bending of guide webs 4 in the inward direction. Finally, guide webs 4 return to their unstressed initial position 4 according to FIG. 7.

To further secure driving element 10 on the rail profile, provided laterally on driving element 10 are marginal webs 19, 17, whereby lateral webs 19 extend substantially perpendicular to the base of driving element 10 and securing webs 17 face towards guide protrusions 5 at an acute angle. According to FIG. 7, centrally thickened section 11 slides directly on the insides of guide webs 4. To secure driving element 10 on the rail profile, a securing section 21 formed on each of the front free ends of securing webs 17 is in direct contact on the opposing surface of guide protrusion 5 facing towards base 2 of the rail profile. The surfaces may be bevelled as described previously on the basis of FIG. 1. In the embodiment according to FIG. 7, these lateral surfaces 9 are convex in shape and securing sections 21 formed correspondingly to them are concave in shape. According to FIG. 7, convex securing section 9 merges into the outer surface of securing web 4 at an obtuse angle, i.e. an angle greater than 90 degrees. Overall, driving element 10 is secured against detachment in the vehicle's transverse direction y by clamping on the rail profile.

FIG. 8 shows a driving element for motor vehicle window lifters according to a further aspect of the following invention, which is suitable for a guide rail assembly, as described previously, but which is also basically suitable for any other rail profiles, also for those that are not made of a plastic material. The guide rail has, in the embodiment according to FIG. 8, two guide webs 4 spaced apart from each other, which are formed according to the first embodiment of FIG. 1. Basically, however, a single guide web 4, from which, for example, two guide protrusions 5 protrude in opposing directions, is also sufficient to guide the driving element. According to FIG. 8, driving element 10 is comprised of two different materials, namely a body 10, which is preferably formed out of a plastic material, particularly is injection moulded out of plastic, in which U-shaped longitudinal recesses are formed, in which U-shaped slider inserts 27 are securely accommodated, said slider inserts being comprised of a different material. This other material is particularly suitable for a particularly appropriate tribological pairing with the material of guide webs 4, may in particular be a metal or a metal insert, also in the form of a sintered body, but may also in principle be comprised of another plastic material. According to FIG. 8, slider inserts 27 engage with a positive fit in the U-shaped longitudinal recesses of driving element 10. Edges 24, 25 on the inside of driving element 10 engage behind edges on the top end of slider inserts 27 to secure slider inserts 27 in the longitudinal recesses.

The following procedure is followed for assembly of such a guide rail assembly: first of all a guide rail is provided, for example with two guide webs 4 spaced apart from one another, as illustrated in FIG. 8. Then slider inserts 27 are pushed onto the front free ends of guide webs 4. At the same time the lateral webs of U-shaped slider inserts 27 must be elastically expanded, which is possible due to the design of the inner sides of the lateral flanks and of guide protrusion 5. Subsequently, driving element 10 in FIG. 8 is pushed onto the guide rail from above with slider inserts 27 attached to it until the bottom ends of slider inserts 27 are in contact on edges 24, 25 or on the introductory bevels formed on these edges, which leads to an elastic expanding of the webs of driving element 10 which form the longitudinal recess. According to FIG. 8, the central section of driving element 10 has a U-shaped longitudinal cut-recess 26, such that the inner side walls of driving element 10 can be bent elastically inwards. On further pushing on of driving element 10, slider inserts 27 finally slide completely into the longitudinal recess of the driving element until then edges 24, 25 finally snap back and engage behind the front ends of slider inserts 27 in order to thus secure driving element 10 against detachment in the vehicle's transverse direction, i.e. in the vertical direction in FIG. 8.

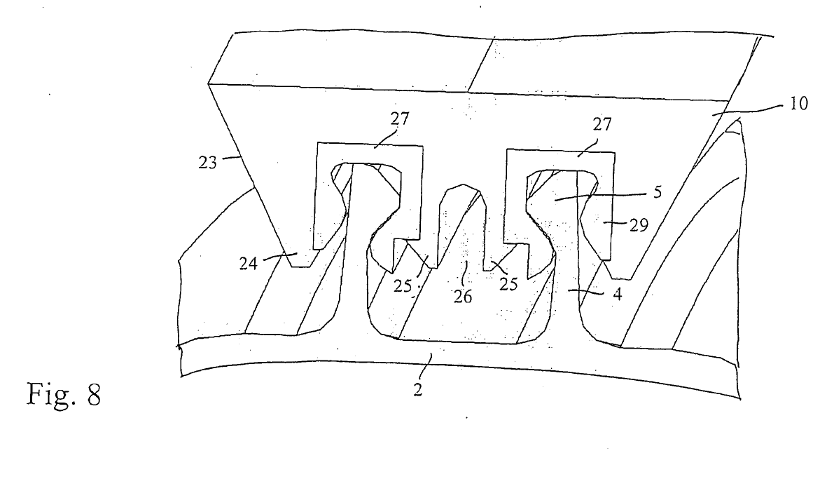

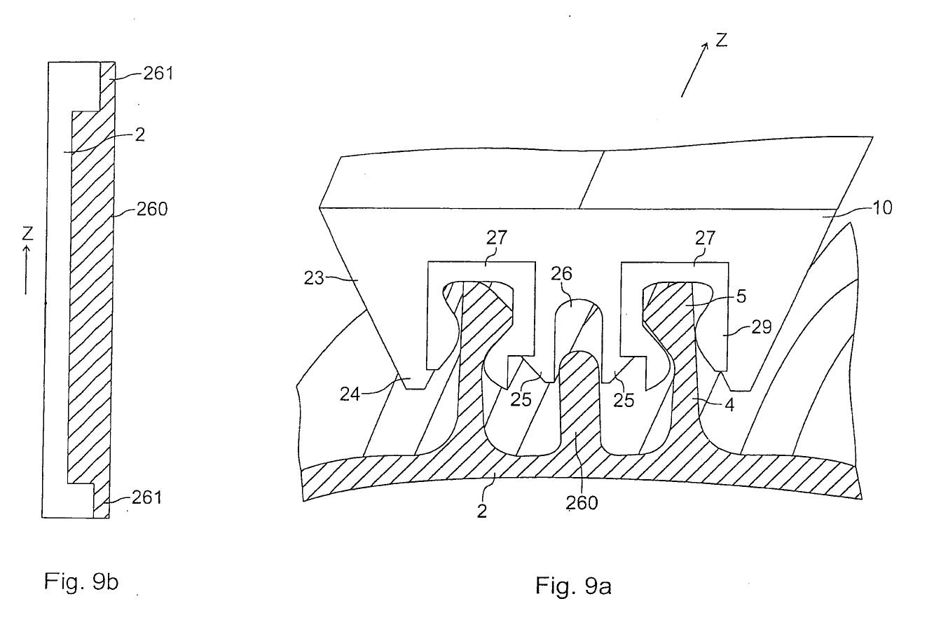

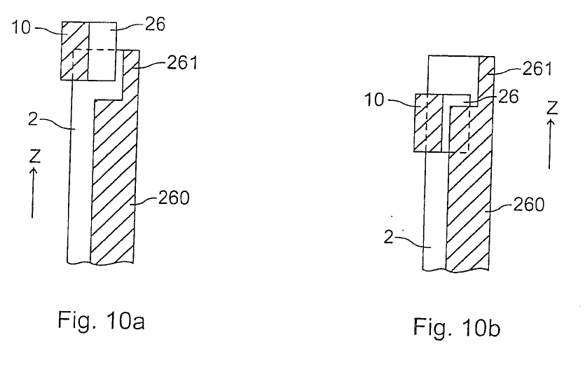

FIG. 9a shows a variation of the guide rail assembly according to FIG. 8. Unlike FIG. 8, standing up from base 2 of the module carrier is a locking web 260, which in the working range of the driving element engages in the U-shaped longitudinal recess or cut-out 26 of driving element 10. Sliding inserts 27 are at the same time clipped into driving element 10, with elastic deformation or bending of securing hooks 25 limiting longitudinal recess 26. In the working range of the driving element, locking web 260 engages in longitudinal recess 26 in such a manner that bending of securing hooks 25 towards one another on detaching driving element 10 perpendicularly from base 2 of the module carrier is prevented. This effectively prevents sliding inserts 27 from popping out of the longitudinal recesses of driving element 10 and secures driving element 10 on guide webs 4.

To be able to assemble the driving element illustrated on guide webs 4 of a carrier 1 provided with locking web 260, said locking web 260 according to FIG. 9b has a narrowed section or cut-out 261 on at least one end region. To assemble the driving element, the positive fit between driving element 10 and protrusions 5 of guide webs 4 may be created first of all by simply clipping on driving element 10 with slider inserts 27 inserted therein in the region of narrowed section 261. On moving driving element 10 within its working range, locking web 260 then engages in recess 26 of the driving element, as described previously, such that large detachment forces acting perpendicular to the module carrier can be transferred. In addition, the width of locking web 260 corresponds in the working range or adjustment range of driving element 10 substantially to the width of longitudinal recess 26 of driving element 10.

It is possible to dispense with the narrowed section or cut-out 261 previously referred to if the geometry of the module carrier allows the driving element to be pushed on in the adjustment direction of driving element 10. The advantage of locking web 260 is therefore, that unintentional bending upwards of securing hooks 25 and thus unbuttoning of protrusions 5 from slider insert 27 can be securely prevented. Of course, for this it is necessary for the outer regions of the driving element or the body of the driving element as such to be designed with sufficient rigidity.

As will clearly be self-explanatory to the person skilled in the art on studying the preceding description, the features of the embodiments described previously may also be combined with each other in any other way than previously described.

### LIST OF REFERENCE NUMBERS

1 Carrier plate

2 Base of guide rail

3 Inside of guide rail

4 Guide web

5 Guide protrusion

6 Introductory bevel

7 Bevel

8 Front face of guide web 4

9 Rounded contact section/guiding section

10 Driving element

11 Central thickened section

12 Narrowing

13 Front face of the central thickened section 11

14 Front bevel

15 Rear bevel

16 Inclined marginal web

17 Securing web

18 Edge

19 Marginal web

20 Securing element

21 Rounded securing section

22 Stiffening rib

23 Bevel

24 Front end

25 Securing hook

26 Recess

260 Locking web

261 Cut-out/narrowed end of locking web 260

27 Sliding insert

28 Inner leg

29 Outer leg

30 First half of moulding tool

31 Second half of moulding tool

32 Wedge insert of moulding tool

33 Central cavity

34 Cavity

35 Narrowing

36 Lateral surface of first half of moulding tool

37 Lateral surface of wedge insert 32

38 Notch

1. A guide rail assembly for motor vehicle window lifters, which is formed of a plastic material, comprising a flat carrier and at least one guide rail for guidance of a window lifter driving element, wherein the guide rail has two guide webs spaced apart from each other and protruding from the carrier and wherein guide protrusions are formed on the guide webs, each of said guide protrusions extending over the entire guidance length of the guide webs and each of said guide protrusions protruding by a predetermined distance inwards or outwards from the respective guide web such that the driving element cooperating with the guide webs is securely guided against detachment perpendicular to the carrier, in which guide rail assembly said guide webs are designed such that in the region of said guide protrusions said guide webs are each elastically bendable inwards or outwards by at least the predetermined distance.

2. The guide rail assembly according to claim 1, wherein the protrusions each have a guide surface facing towards the carrier and a bevel facing away from the carrier, a notational extension of said guide surface including a first acute angle with a line perpendicular to said carrier, and a notional extension of said bevel including a second acute angle with the line perpendicular to said carrier.

3. The guide rail assembly according to claim 2, wherein the first acute angle is smaller than the second acute angle.

4. The guide rail assembly according to claim 1, in which the guide protrusions each have, on a side facing the carrier, a convex guide surface which merges into said guide web at an obtuse angle.

5. The guide rail assembly according to claim 1 wherein the guide webs in the region of the guide protrusions are each bendable elastically inwards or outwards by said predetermined distance on operation of a minimum force, which minimum force corresponds to a force that is required for demoulding of the guide rail of plastic material from a moulding tool.

6. The guide rail assembly according to claim 1, further comprising a window lifter driving element for connecting a window pane to the window lifter, wherein the driving element has contact sections, which are formed in correspondence to the guide protrusions and cooperate therewith in order to guide the driving element securely perpendicular to the carrier to prevent detachment.

7. The guide rail assembly according to claim 6, wherein securing means, which counteract or prevent bending of the guide webs, are respectively formed on the driving element.

8. The guide rail assembly according to claim 7, wherein the driving element has a central protrusion, which protrudes into an inner space of the guide rail and is guided there in the guide rail's longitudinal direction, wherein the securing means are disposed on an outside of the guide webs.

9. The guide rail assembly according to claim 7, wherein the securing means are permanently in contact on the outside of the guide web.

10. The guide rail assembly according to claim 8, wherein the central protrusion is thickened in a mushroom shape in the inner space of the guide rail and engages with a positive fit in the guide protrusions formed on the insides of the guide webs, wherein the securing means are resilient webs, which rest on the outside of the guide webs.

11. The guide rail assembly according to claim 10, wherein front free ends of the resilient webs are inclined at an acute angle and, directed towards a base of the driving element, towards the outsides of the guide webs.

12. The guide rail assembly according to claim 11, wherein the mushroom-shaped thickening of the central protrusion and the inclined front free ends of the resilient webs are disposed at different distances from the base of the driving element or from the carrier.

13. The guide rail assembly according to claim 10, wherein the protrusions are provided on the outsides of the guide webs and contact surfaces are provided on the front free end of the resilient webs, said contact surfaces being formed in correspondence to the guide protrusions.

14. The guide rail assembly according to claim 13, wherein the contact surfaces are formed as concave, dished webs.

15. The guide rail assembly according to claim 6, wherein an introductory bevel is provided on the side of the guide protrusions facing away from the carrier, said bevel coming into contact with at least one of a central protrusion of the driving element and the securing means on introduction of the driving element into the guide rail to thereby cause an elastic bending of one of the guide webs of the guide rail and the securing means.

16. The guide rail assembly according to claim 1, wherein the carrier is designed as a flat carrier plate, with which one or two guide rails are integrally formed, for pre-assembly of door module components on the carrier plate.

17. A method for the production of a guide rail assembly by means of injection moulding from a plastic material, for motor vehicle window lifters, which is formed of a plastic material, said guide rail assembly comprising a flat carrier and at least one guide rail for guidance of a window lifter driving element, wherein the guide rail has two guide webs spaced apart from each other and protruding from the carrier and wherein guide protrusions are formed on the guide webs, each of said guide protrusions extending over the entire guidance length of the guide webs and each of said guide protrusions protruding by a predetermined distance inwards or outwards from the respective guide web such that the driving element cooperating with the guide webs is securely guided against detachment perpendicular to the carrier, said method comprising the steps of:
providing a moulding tool having at least three movable moulding tool parts, which together form a first cavity for formation of the flat carrier and two second cavities for formation of the guide webs and guide protrusions;
injection moulding of the guide rail assembly from the plastic material within the moulding tool;
and removing the guide rail assembly from the moulding tool; during which process one moulding tool part defining the interior of the guide rail is wedge-shaped and is disposed between two adjacent moulding tool parts and all of the at least three movable moulding tool parts are withdrawn in the same direction on removal.

18. The method according to claim 17, wherein on demoulding first the two adjacent moulding tool parts are withdrawn and subsequently the wedge-shaped moulding tool part with elastic bending of the guide webs is withdrawn.

19. The method according to claim 17, wherein during demoulding first the two adjacent moulding tool parts are withdrawn and subsequently the wedge-shaped moulding tool part is withdrawn with elastic bending of the guide webs.

20. A driving element for a guide rail assembly according to claim 1, which driving element is designed to be movably guided in the longitudinal direction of a guide rail of the window lifter and to be secured perpendicular to the longitudinal direction, comprising a body, which has at least one U-shaped longitudinal recess and is made of a first material, and at least one sliding insert formed from a second material that is different from the first material, which is held securely in the longitudinal recess, wherein the sliding insert has a guide groove, which is formed at least in sections correspondingly to a guide web of the guide rail.

21. The driving element according to claim 20, further comprising securing means for securely holding each sliding insert in the relevant longitudinal recess.

22. The driving element according to claim 21, wherein the securing means are protruding longitudinal edges of the longitudinal recess.

23. The driving element according to claim 21, wherein the respective longitudinal recess is U-shaped and the respective sliding insert is clipped into the longitudinal recess.

24. The driving element according to claim 20, wherein the driving element has two sliding inserts spaced apart from each other and wherein between the sliding inserts there is formed a central web having securing hooks on its front, free end in which a central longitudinal cut-out is formed.

25. The guide rail assembly according to claim 1, further comprising a driving element which is designed to be movably guided in the longitudinal direction of a guide rail of the window lifter and to be secured perpendicular to the longitudinal direction, said driving element comprising a body, which has at least one U-shaped longitudinal recess and is made of a first material, and at least one sliding insert formed from a second material that is different from the first material, which is held securely in the longitudinal recess, wherein the sliding insert has a guide groove, which is formed at least in sections correspondingly to a guide web of the guide rail, wherein the longitudinal recess is formed in the driving element and wherein furthermore a locking web protrudes from the carrier, which engages in the longitudinal recess in such a manner as to counteract at least one of bending of surfaces of the driving element which form the longitudinal recess and popping out of the at least one sliding insert from the associated U-shaped longitudinal recess on detachment of the driving element perpendicular to a plane defined by the carrier.

26. The guide rail assembly according to claim 25, wherein close to at least one end region of the guide webs of the carrier at least one of a narrowed section and a cut-out is provided on the locking web.

27. A method for the assembly of a guide rail assembly for motor vehicle window lifters, comprising a driving element wherein said guide rail assembly is formed of a plastic material and comprises a flat carrier and at least one guide rail for guidance of said driving element, wherein the guide rail has two guide webs spaced apart from each other and protruding from the carrier and wherein guide protrusions are formed on the guide webs, each of said guide protrusions extending over the entire guidance length of the guide webs and each of said guide protrusions protruding by a predetermined distance inwards or outwards from the respective guide web such that the driving element cooperating with the guide webs is securely guided against detachment perpendicular to the carrier, in which guide rail assembly said guide webs are designed such that in the region of said guide protrusions said guide webs are each elastically bendable inwards or outwards by at least the predetermined distance;
and wherein said driving element is designed to be movably guided in the longitudinal direction of the guide rail of the window lifter and to be secured perpendicular to the longitudinal direction,
said driving element comprising a body, which has at least one U-shaped longitudinal recess and is made of a first material, and at least one sliding insert formed from a second material that is different from the first material, which is held securely in the relevant longitudinal recess, wherein the sliding insert has a guide groove, which is formed at least in sections correspondingly to a guide web of the guide rail;
said method comprising the steps of:
placing of each sliding insert on the associated guide web such that the guide groove formed therein cooperates at least in sections in the manner of a positive fit;
placing of the body of the driving element on at least one said guide web such that the relevant sliding insert is accommodated in the associated longitudinal recess of the body; and
securing of the relevant sliding insert on the body such that the driving element is movably guided on each guide web in the longitudinal direction thereof and is secured in a direction perpendicular thereto.

28. A method for the assembly of a guide rail assembly for motor vehicle window lifters comprising a driving element
wherein said guide rail assembly is formed of a plastic material and comprises a flat carrier and at least one guide rail for guidance of said driving element, wherein
the guide rail has two guide webs spaced apart from each other and protruding from the carrier and wherein
guide protrusions are formed on the guide webs,
each of said guide protrusions extending over the entire guidance length of the guide webs and
each of said guide protrusions protruding by a predetermined distance inwards or outwards from the respective guide web such that the driving element cooperating with the guide webs is securely guided against detachment perpendicular to the carrier,
in which guide rail assembly said guide webs are designed such that in the region of said guide protrusions said guide webs are each elastically bendable inwards or outwards by at least the predetermined distance;
and wherein said driving element is designed to be movably guided in the longitudinal direction of the guide rail of the window lifter and to be secured perpendicular to the longitudinal direction,
said driving element comprising a body, which has at least one U-shaped longitudinal recess and is made of a first material, and at least one sliding insert formed from a second material that is different from the first material, which is held securely in the relevant longitudinal recess, wherein the sliding insert has a guide groove, which is formed at least in sections correspondingly to a guide web of the guide rail;
said method comprising the steps of:
inserting the respective sliding insert in the associated U-shaped longitudinal recess of the driving element in order to form a pre-assembled driving element unit consisting of the driving element and of at least one sliding insert;
placing the pre-assembled driving element unit on the associated guide webs in such a manner that the driving element is movably guided on the respective guide web in the longitudinal direction thereof and is secured in a direction perpendicular thereto; and
sliding the driving element into a region, in which the locking web of the carrier engages in the longitudinal recess of the driving element in such a manner as to counteract at least one of bending of surfaces of the driving element forming the longitudinal recess and popping of the at least one sliding insert out of the associated U-shaped longitudinal recess on detachment of the driving element perpendicular to a plane defined by the carrier.

29. (canceled)

30. The method according to claim 28, wherein on placing the body each sliding insert is clipped into the associated longitudinal recess.
